(19) United States
(12) Patent Application Publication
(10) Pub. No.: US 2009/0208024 A1
(43) Pub. Date: Aug. 20, 2009

(54) APPARATUS FOR REDUCING THE RISK OF NOISE INDUCED HEARING LOSS

(75) Inventors: Niels Farver, Knebel (DK); Mads Rugholm, Silkeborg (DK)

Correspondence Address: CANTOR COLBURN, LLP, 20 Church Street, 22nd Floor, Hartford, CT, 06103, US

(73) Assignee: MICROSOUND A/S, Silkeborg (DK)

(21) Appl. No.: 12/301,060

(22) PCT Filed: May 16, 2007
(86) PCT No.: PCT/DK2007/000233

§ 371 Date: Nov. 17, 2008

(30) Foreign Application Priority Data
May 16, 2006 (DK) PA 2006 00691

(51) Int. Cl. H04R 29/00

(52) U.S. Cl. 381/56

(57) ABSTRACT

An apparatus is disclosed for managing the joint contribution of noise exposure of the ear of a user of the apparatus from a loudspeaker of the apparatus as well as from ambient noise so that the risk of risk of noise induced hearing losses is reduced. By assessing the joint actual sound energy delivered to the ear and feeding said assessment to a model describing the accumulated risk of hearing loss due to said sound energy accumulated over a time period, an estimate of the current risk of hearing loss is obtained. When said risk estimate passes a predetermined threshold, one or more protective measures are taken.

The present invention comprises a method and apparatus for reducing the risk of noise induced hearing loss.

### BACKGROUND

The risk of hearing losses due to noise exposure is well known, in particular for sudden noises of a very high sound energy, such as from firearms. Exposure to high levels of sound energy over longer time periods may also be a risk of causing hearing losses.

According to audiological research there is a close relationship between the likelihood of hearing loss and noise exposure in terms of both level and duration. The following table shows data from a standard proposed June 1998 by the U.S. Department Of Health And Human Services

TABLE 1-1
Combinations of noise exposure levels and durations
that no worker exposure shall equal or exceed

| Exposure | | | |
|---|---|---|---|
| level, L | Duration, T | | |
| (dBA) | Hours | Minutes | Seconds |
| 80 | 25 | 24 | — |
| 81 | 20 | 10 | — |
| 82 | 16 | — | — |
| 83 | 12 | 42 | — |
| 84 | 10 | 5 | — |
| 85 | 8 | — | — |
| 86 | 6 | 21 | — |
| 87 | 5 | 2 | — |
| 88 | 4 | — | — |
| 89 | 3 | 10 | — |
| 90 | 2 | 31 | — |
| 91 | 2 | — | — |
| 92 | 1 | 35 | — |
| 93 | 1 | 16 | — |
| 94 | 1 | — | — |
| 95 | — | 47 | 37 |
| 96 | — | 37 | 48 |
| 97 | — | 30 | — |
| 98 | — | 23 | 49 |
| 99 | — | 18 | 59 |
| 100 | — | 15 | — |
| 101 | — | 11 | 54 |
| 102 | — | 9 | 27 |
| 103 | — | 7 | 30 |
| 104 | — | 5 | 57 |
| 105 | — | 4 | 43 |
| 106 | — | 3 | 45 |
| 107 | — | 2 | 59 |
| 108 | — | 2 | 22 |
| 109 | — | 1 | 53 |
| 110 | — | 1 | 29 |
| 111 | — | 1 | 11 |
| 112 | — | — | 56 |
| 113 | — | — | 45 |
| 114 | — | — | 35 |
| 115 | — | — | 28 |
| 116 | — | — | 22 |
| 117 | — | — | 18 |
| 118 | — | — | 14 |
| 119 | — | — | 11 |
| 120 | — | — | 9 |
| 121 | — | — | 7 |
| 122 | — | — | 6 |
| 123 | — | — | 4 |
| 124 | — | — | 3 |
| 125 | — | — | 3 |
| 126 | — | — | 2 |
| 127 | — | — | 1 |
| 128 | — | — | 1 |
| 129 | — | — | 1 |
| 130-140 | — | — | <1 |
| — | — | — | — |

Source: DHHS (NIOSH) Publication No. 98-126 “Criteria for a Recommended Standard”

U.S. DEPARTMENT OF HEALTH AND HUMAN SERVICES

Public Health Service

Centers for Disease Control and Prevention

National Institute for Occupational Safety and Health

Cincinnati, Ohio

As the level changes over time, a method for calculating the effective noise dose is needed.

In the abovementioned publication DHHS (NIOSH) Publication No. 98-126 “Criteria for a Recommended Standard” the so-called noise dose (D) is used to calculate the combined effect of the sound energy:

### 1.1.3 Daily Noise Dose

When the daily noise exposure consists of periods of different noise levels, the daily dose (D) shall not equal or exceed 100, as calculated according to the following formula:

D=[C₁/T₁+C₂/T₂+ . . . +Cₙ/Tₙ]×100

where

Cₙ=total time of exposure at a specified noise level, and

Tₙ=exposure duration for which noise at this level becomes hazardous.

The daily dose can be converted into an 8-hr TWA according to the following formula (or as shown in Table 1-2):

TWA=10.0×Log(D/100)+85

TABLE 1-2
Daily noise dose as an 8-hr TWA*

| | dBA as |
|---|---|
| Dose (%) | 8-hr TWA |
| 20 | 78.0 |
| 30 | 79.8 |
| 40 | 81.0 |
| 50 | 82.0 |
| 60 | 82.8 |
| 70 | 83.5 |
| 80 | 84.0 |
| 90 | 84.5 |
| 100 | 85.0 |
| 110 | 85.4 |
| 120 | 85.8 |
| 130 | 86.1 |
| 140 | 86.5 |
| 150 | 86.8 |
| 170 | 87.3 |
| 200 | 88.0 |
| 250 | 89.0 |
| 300 | 89.8 |
| 350 | 90.4 |
| 400 | 91.0 |
| 450 | 91.5 |
| 500 | 92.0 |
| 550 | 92.4 |
| 600 | 92.8 |
| 650 | 93.1 |
| 700 | 93.5 |
| 750 | 93.8 |
| 800 | 94.0 |
| 900 | 94.5 |
| 1,000 | 95.0 |
| 1,050 | 95.2 |
| 1,100 | 95.4 |
| 1,150 | 95.6 |
| 1,200 | 95.8 |
| 1,300 | 96.1 |
| 1,400 | 96.5 |
| 1,500 | 96.8 |
| 1,600 | 97.0 |
| 1,700 | 97.3 |
| 1,800 | 97.6 |
| 1,900 | 97.8 |
| 2,000 | 98.0 |
| 2,500 | 99.0 |
| 3,000 | 99.8 |
| 3,500 | 100.4 |
| 4,000 | 101.0 |
| 4,500 | 101.5 |
| 5,000 | 102.0 |
| 6,000 | 102.8 |
| 7,000 | 103.5 |
| 8,000 | 104.0 |
| 9,000 | 104.5 |
| 10,000 | 105.0 |
| 12,000 | 105.8 |
| 14,000 | 106.5 |
| 16,000 | 107.0 |
| 18,000 | 107.6 |
| 20,000 | 108.0 |
| 25,000 | 109.0 |
| 30,000 | 109.8 |
| 35,000 | 110.4 |
| 40,000 | 111.0 |
| 45,000 | 111.5 |
| 50,000 | 102.0 |
| 60,000 | 112.8 |
| 70,000 | 113.5 |
| 80,000 | 114.0 |
| 90,000 | 114.5 |
| 100,000 | 115.0 |
| 110,000 | 115.4 |
| 120,000 | 115.8 |
| 130,000 | 116.1 |
| 140,000 | 116.5 |
| 150,000 | 116.8 |
| 175,000 | 117.4 |
| 200,000 | 118.0 |
| 225,000 | 118.5 |
| 250,000 | 119.0 |
| 275,000 | 119.4 |
| 300,000 | 119.8 |
| 350,000 | 120.4 |
| 400,000 | 121.0 |
| 450,000 | 121.5 |
| 500,000 | 122.0 |
| 600,000 | 122.8 |
| 700,000 | 123.5 |
| 800,000 | 124.0 |
| 900,000 | 124.5 |
| 1,000,000 | 125.0 |
| 1,100,000 | 125.4 |
| 1,200,000 | 125.8 |
| 1,300,000 | 126.1 |
| 1,400,000 | 126.5 |
| 1,600,000 | 127.0 |
| 1,800,000 | 127.6 |
| 2,000,000 | 128.0 |
| 2,200,000 | 128.4 |
| 2,400,000 | 128.8 |
| 2,600,000 | 129.1 |
| 2,800,000 | 129.5 |
| 3,000,000 | 129.8 |
| 3,500,000 | 130.4 |
| 4,000,000 | 131.0 |
| 4,500,000 | 131.5 |
| 5,000,000 | 132.0 |
| 6,000,000 | 132.8 |
| 7,000,000 | 133.5 |
| 8,000,000 | 134.0 |
| 9,000,000 | 134.5 |
| 10,000,000 | 135.0 |
| 12,000,000 | 135.8 |
| 14,000,000 | 136.5 |
| 16,000,000 | 137.0 |
| 18,000,000 | 137.6 |
| 20,000,000 | 138.0 |
| 22,000,000 | 138.4 |
| 24,000,000 | 138.8 |
| 26,000,000 | 139.0 |
| 28,000,000 | 139.5 |
| 30,000,000 | 139.8 |
| 32,500,000 | 140.1 |

*TWA = 10 × Log(D/100) + 85

Devices for hearing protection employing these or similar methods for monitoring the exposure to external noise are known in the art, such as from U.S. Pat. No. 6,456,199 and from US 2003/0088324. In US 2003/191609 a headset is disclosed, wherein the sound level provided from the headset to the user is estimated from an input sound signal and is controlled based on a calculated cumulative exposure to sound so as to protect the user.

The object of the present invention is to provide an improved apparatus and method for reducing the risk of human hearing losses.

### BRIEF DESCRIPTION OF THE INVENTION

The above-stated object is fulfilled by the present invention, which relates to a method and an apparatus for managing the joint contribution of noise exposure of the ear of a user of the apparatus from a loudspeaker of the apparatus as well as from ambient noise so that the risk of risk of noise induced hearing losses is reduced.

By assessing the actual sound energy delivered to the ear and feeding said assessment to a model describing the accumulated risk of hearing loss due to said sound energy accumulated over a time period, an estimate of the current risk of hearing loss is obtained. When said risk estimate passes a predetermined threshold, one or more protective measures can be taken.

As outlined in the background, the risk of noise induced hearing loss increases with the time averaged sound power to which the ear has been exposed. The ‘Equal Energy Hypothesis’—stating that equal amounts of sound energy will produce approximately equal amounts of hearing impairment—seems well supported by scientific evidence.

Various types of devices that deliver sound energy to the ear for different purposes may benefit from including means for assessing the amount of sound energy to which the ear has been exposed and use that assessment to warn the wearer of the increased risk of hearing impairment and/or take other precautionary measures such as limiting the sound pressure.

Hearing aids or assistive listening devices deliver amplified and maybe enhanced sound to the ear. Such devices may therefore increase the risk of inducing (additional) hearing loss. This risk is to some extent lowered by the use of compression or output limiting so that only soft sounds are amplified and loud sounds may even be attenuated. However, the total amount of energy experienced by the ear with the device will almost always be larger than it would have been without the device.

The invention described here pertains to the concept of monitoring the sound energy delivered to the ear and—using an appropriate model—estimate the risk of hearing loss being induced and if possible minimize that risk by changing the signal processing in the device.

Changing the signal processing to limit the energy after prolonged exposure to loud sound works well in devices that effectively seals the entrance to the ear canal such as active hearing protectors.

Other devices, such as hearing aids for mild to moderate high frequency hearing losses do however use a very open fit to avoid the annoying phenomenon known as occlusion. Such a device can limit the energy delivered from the output transducer, but the sound entering through the vent is hard to cancel. To warn the wearer, an indication of the potentially hazardous situation can be given by the device. This could be by playing back warning sounds with a suitable interval.

Even hearing protectors could benefit from using warning signals, since the attenuation of external sound is not necessarily very large and varies with frequency. Based on abovementioned modeling, the hearing protector may warn the wearer that the protection is not sufficient prompting him or her to leave the noisy surroundings or change to a more effective—but maybe less comfortable—means of hearing protection.

The assessment of the level of the sound energy delivered to the user's ear is made from an assessment of the joint contribution from the surroundings and from the apparatus itself. The assessment of the contribution from the surroundings may be based on a measurement of the sound level outside the ear, e.g. from a microphone on the apparatus and from a set of data describing the damping of the surrounding sound by the part of the apparatus covering the ear opening and/or being situated in the ear channel. The contribution from the apparatus itself may be assessed from the output from the data processing unit, preferably a digital data processing unit as is well-known from digital hearing prostheses, to the loudspeaker.

The output from the comparison may be a warning that the allowed threshold value for the day is being exceeded. Alternatively, the threshold value used for comparison is linked to a time period, e.g. that two hours into a predetermined time period of eight hours, the assessed noise exposure dose D is compared to the threshold value for the first two hours of an eight hour period, and in case that threshold value is exceeded, the gain of the sound transmitted from a microphone to a loudspeaker in the ear is reduced in order to prevent the threshold value for the whole period to be exceeded. The reduced gain may be changed to normal gain later in the predetermined time period depending on the level of sound energy delivered to the user's ear in a period after the reduction of the gain.

Thus, the present invention relates to an apparatus comprising

at least one loudspeaker for providing a sound output to a user's ear,

a microphone for measuring an ambient sound level, and

data processing means arranged for

estimating the level of the sound energy delivered to the user's ear from the joint contribution from said the sound output provided to the user's ear by means of said at least one loudspeaker and from the measured ambient sound level arriving to the user's ear through an acoustic leakage path,

performing a time based integration of said level of sound energy to obtain a value characterizing the noise exposure dose (D) of the user's ear,

comparing said value with a threshold value or set of threshold values, and

providing an output from said comparison.

The microphone may be one employed to record the voice of the user of the apparatus, in particular when the apparatus is a headset for two-way communication, e.g. a telephone, the microphone may alternatively be used to obtain an ambient sound signal to be processed by the data processing means and fed to the loudspeaker for the apparatus being a hearing aid, or the microphone may be dedicated for the detection of ambient noise signals for the estimation of the joint sound energy.

Thus, the one or more loudspeakers may provide a sound output based on an input from the microphone and/or from an external sound signal, such as a voice signal.

The contribution from the ambient sound level may be obtained by using a filtered version of a signal from said microphone, in particular by using a transfer function of the filter which is regularly updated according to an estimate of the acoustical leakage path.

Said estimate of said acoustical leakage path transfer function may in particular be derived from an estimate of the feed-back path from said loudspeaker to said microphone.

The data processing means may in particular be arranged to perform said time based integration over a predetermined period of time, in a preferred embodiment is the length of said period of time is within the range of 2 to 16 hours, preferably within the range of 4 to 12 hours.

Alternatively or additionally, the length is said period of time may be defined by the user of the apparatus.

The data processing means may furthermore comprise means for calculating said predefined threshold value or set of threshold values from a risk estimation model stored within data storage means associated with said data processing means. In particular, the data storage means may comprise means for storage of user specific data, and the data processing means is arranged to retrieve said user specific data and apply them for the calculation of calculating said predefined threshold value or set of threshold values from the risk estimation model.

The present invention relates furthermore to a method for reducing the risk of noise induced hearing loss by use of an apparatus comprising

at least one loudspeaker for providing a sound output to a user's ear, and

a microphone for measuring an ambient sound level outside the user's ear, the method comprising the steps of

estimating the level of the sound energy delivered to the user's ear from the joint contribution from said the sound output provided to the user's ear by means of said at least one loudspeaker and from the measured ambient sound level arriving to the user's ear through an acoustic leakage path,

performing a time based integration of said level of sound energy to obtain a value characterizing the noise exposure dose (D) of the user's ear,

comparing said value with a threshold value or set of threshold values, and

providing an output from said comparison.

In one preferred embodiment, the apparatus is able to control the sound energy delivered to the ear and can therefore gradually decrease said sound energy as the risk of noise induced hearing loss increases.

In another preferred embodiment, the apparatus cannot effectively limit the sound energy to the ear. In this embodiment the wearer is given a warning signal, so the wearer may take steps to reduce the noise exposure, for instance by leaving the noisy area.

Presently, the application of this invention is especially useful in the area of hearing instruments, since such devices amplify sounds from the surroundings thereby potentially worsening the hearing of the wearer.

The model used to estimate the risk of impairment may be adjusted using knowledge of the wearers hearing. If, for instance, a substantial part of the wearers hearing loss is due to conductive (middle ear) problems, the wearer may tolerate more sound energy than otherwise.

Another application could be in sound playback devices such as MP3 players, which have recently been shown to cause hearing loss due to users listening at unsafe levels.

### BRIEF DESCRIPTION OF THE FIGURES

An example of an apparatus according to the present invention is shown in the accompanying figures of which

FIG. 1 illustrates the apparatus in use, and

FIG. 2 is a diagram of the technical function of the apparatus.

The example is provided in order to explain aspects of the present invention and improve the understanding thereof and should not be regarded as delimiting the scope of protection of the appended claims.

### DESCRIPTION OF AN EMBODIMENT

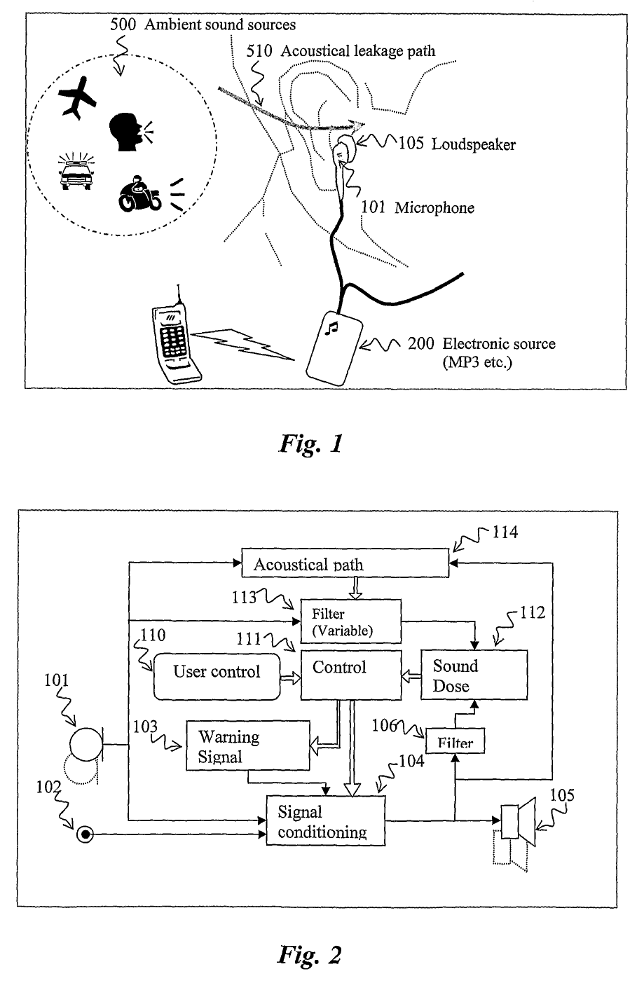

A headset according to the present invention is illustrated in FIGS. 1 and 2. The headset comprises an earplug having a loudspeaker 105 and a microphone 101 arranged on the outside in order to measure the sound level of ambient sound sources 500. The headset is connected to a source 200 delivering a sound signal that is processed through signal conditioning means 105 and fed to the loudspeaker 105 in order to provide sound to the user's ear. This source 200 may provide an internal sound signal, e.g. music data stored in the source and/or an external sound signal, such as a telephone sound signal, a radio broadcasted signal etc.

A representation of the signal to be presented via the loudspeaker 105 is fed from 102 via the signal conditioning 104 through an electro-acoustical transfer function modeling filter 106 and the contribution to the sound dose is integrated in Sound Dose calculation means 112, which also integrates the contribution from airborne ambient sound as estimated using the signal from the microphone 101 filtered by leakage path modeling filter 113. Said filter 113 may be updated by acoustical path estimation means 114 using methods from adaptive filter theory as used in feed-back path estimation. A mapping from the feed-back transfer function to the desired transfer function is involved. Control means 111 receives commands from User Control means 110 and state information from Sound dose calculation means 112 to control the operating mode of the system. Especially as the accumulated sound dose rises to near critical levels, the signal conditioning 104 and the warning signal generator 103 are employed to lower the risk of noise induced hearing loss and/or warn the user of the condition.

1. An apparatus comprising
at least one loudspeaker for providing a sound output to a user's ear,
a microphone for measuring an ambient sound level, and
data processing means arranged for
estimating the sound energy delivered to the user's ear by estimating the contribution from the sound output provided to the user's ear by means of said at least one loudspeaker, by estimating the contribution from the measured ambient sound level arriving to the user's ear through an acoustic leakage path, and from said two estimated contributions calculate the joint contribution to the level of sound energy,
performing a time based integration of said level of sound energy to obtain a value characterizing the noise exposure dose (D) of the user's ear,
comparing said value with a threshold value or set of threshold values, and
providing an output from said comparison.

2. An apparatus according to claim 1, wherein said contribution from the ambient sound level is obtained by using a filtered version of a signal from said microphone.

3. An apparatus according to claim 2, wherein the transfer function of the filter is updated according to an estimate of the acoustical leakage path.

4. An apparatus according to claim 3, wherein said estimate of said acoustical leakage path transfer function is derived from an estimate of the feed-back path from said loudspeaker to said microphone.

5. An apparatus according to any of the preceding claims, wherein the data processing means are arranged to perform said time based integration over a predetermined period of time.

6. An apparatus according to claim 5, wherein the length of said period of time is within the range of 2 to 16 hours.

7. An apparatus according to claim 5, wherein the length is said period of time may be defined by the user of the apparatus.

8. An apparatus according to claim 1, wherein the data processing means comprises means for calculating said predefined threshold value or set of threshold values from a risk estimation model stored within data storage means associated with said data processing means.

9. An apparatus according to claim 8, wherein the data storage means comprises means for storage of user specific data, and the data processing means is arranged to retrieve said user specific data and apply them for the calculation of calculating said predefined threshold value or set of threshold values from the risk estimation model.

10. An apparatus according to any claim 1, wherein the data processing means is arranged to reduce the sound level of the sound output provided to the user's ear from the loudspeaker from a predetermined sound level in response to said output from said comparison.

11. An apparatus according to claim 1 comprising at least one microphone arrangement, wherein the data processing unit is arranged for receiving an input from said microphone arrangement and providing an output to the loudspeaker based on said input from the microphone arrangement.

12. An apparatus according to claim 1 comprising receiving means for receiving an external signal, wherein the data processing unit is arranged for providing an output to the loudspeaker based on said external signal.

13. Method for reducing the risk of noise induced hearing loss by use of an apparatus comprising
at least one loudspeaker for providing a sound output to a user's ear, and
a microphone for measuring an ambient sound level outside the user's ear, the method comprising the steps of
estimating the contribution of sound energy delivered to the user's ear from the sound output provided to the user's ear by means of said at least one loudspeaker,
estimating the contribution of sound energy delivered to the user's ear from the measured ambient sound level arriving to the user's ear through an acoustic leakage path,
estimating the level of the sound energy delivered to the user's ear from the joint contribution of of said two estimated contributions,
performing a time based integration of said level of sound energy to obtain a value characterizing the noise exposure dose (D) of the user's ear,
comparing said value with a threshold value or set of threshold values, and
providing an output from said comparison.

14. Method according to claim 13, using an apparatus comprising
at least one loudspeaker for providing a sound output to a user's ear,
a microphone for measuring an ambient sound level and
data processing means arranged for
estimating the sound energy delivered to the user's ear by estimating the contribution from the sound output provided to the user's ear by means of said at least one loudspeaker, by estimating the contribution from the measured ambient sound level arriving to the user's ear through an acoustic leakage path, and from said two estimated contributions calculate the joint contribution to the level of sound energy,
performing a time based integration of said level of sound energy to obtain a value characterizing the noise exposure dose (D) of the user's ear,
comparing said value with a threshold value or set of threshold values, and
providing an output from said comparison.
